(19) United States
(12) Patent Application Publication
(10) Pub. No.: US 2008/0030409 A1
(43) Pub. Date: Feb. 7, 2008

(54) Rotational antenna apparatus for GPS device

(76) Inventor: Yih Lieh Shih, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/498,239

(22) Filed: Aug. 3, 2006

(51) Int. Cl. H01Q 1/24

(52) U.S. Cl. 343/702

(57) ABSTRACT

A rotational antenna apparatus for GPS device includes a receiving antenna, a coupling shaft and a rotational stage. The receiving antenna includes a satellite receiving module and a pair of coupling legs on one end thereof. The coupling shaft is of circular cap shape and includes a pair of coupling holes on circumference thereof and corresponding to the coupling legs such that the receiving antenna can be pivotally connected to the coupling shaft and the receiving antenna has 180 degree rotation with the coupling hole as a pivot. The rotational stage is fixed to a casing of the GPS device and includes a pivotal hole through the casing, a tenon pivotally connected to the pivotal hole, wherein the coupling hole is pivotally connected to the coupling leg of the receiving antenna and the receiving antenna has 360 degree rotation with the pivotal hole as a pivot.

### BACKGROUND OF THE INVENTION

1. Field of the Invention

The present invention relates to a rotational antenna apparatus for GPS device, especially to a rotational antenna apparatus for GPS device, where the angle receiving antenna can be freely adjusted to enhance signal reception ability.

2. Description of the Prior Art

Global positioning system (GPS) devices are widely used for navigation service to vehicle user. Moreover, the GPS devices are also provided in smart phone or personal digital assistance (PDA) for providing navigation service to vehicle user. The conventional GPS device generally includes a main body with display screen and is connected to a satellite receiver for receiving satellite positioning signals. Therefore, the geographic location of vehicle user can be located and the geographic location of vehicle user can be shown by referencing to map data in the GPS devices.

Taking hand-held GPS devices as example, the satellite receiving antenna thereof can be of bar-shape, panel shape or hidden style. However, the existing antenna has fixed receiving pattern and the directivity thereof is preferably toward sky; while the hand-held GPS device is designed for portrait or landscape orientation. Therefore, the signal reception is poor when the hand-held GPS device is placed in landscape orientation for operation.

It is desirable to provide a rotational antenna for overcome above-mentioned problem, where the rotational antenna can freely adjust the reception angle thereof to enhance signal reception ability.

### SUMMARY OF THE INVENTION

It is an object of the present invention to provide a rotational antenna apparatus for GPS device, where the angle receiving antenna can be freely adjusted to enhance signal reception ability.

Accordingly, the present invention provides a rotational antenna apparatus for GPS device, which includes a receiving antenna, a coupling shaft and a rotational stage. The receiving antenna includes a satellite receiving module and a pair of coupling legs on one end thereof. The coupling shaft is of circular cap shape and includes a pair of coupling holes on circumference thereof and corresponding to the coupling legs such that the receiving antenna can be pivotally connected to the coupling shaft and the receiving antenna has 180 degree rotation with the coupling hole as a pivot. The rotational stage is fixed to a casing of the GPS device and includes a pivotal hole through the casing, a tenon pivotally connected to the pivotal hole, wherein the coupling hole is pivotally connected to the coupling leg of the receiving antenna and the receiving antenna has 360 degree rotation with the pivotal hole as a pivot.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a perspective view of the GPS device with a rotational antenna apparatus according to the present invention.

FIG. 2 is an exploded view of the rotational antenna apparatus for the GPS device according to the present invention.

FIG. 3 is sectional view of the rotational antenna apparatus for the GPS device according to the present invention.

FIG. 4 shows the rotational antenna apparatus for the GPS device with 180 degree rotation.

FIG. 5 shows the rotational antenna apparatus for the GPS device with 360 degree rotation.

### DETAILED DESCRIPTION OF THE INVENTION

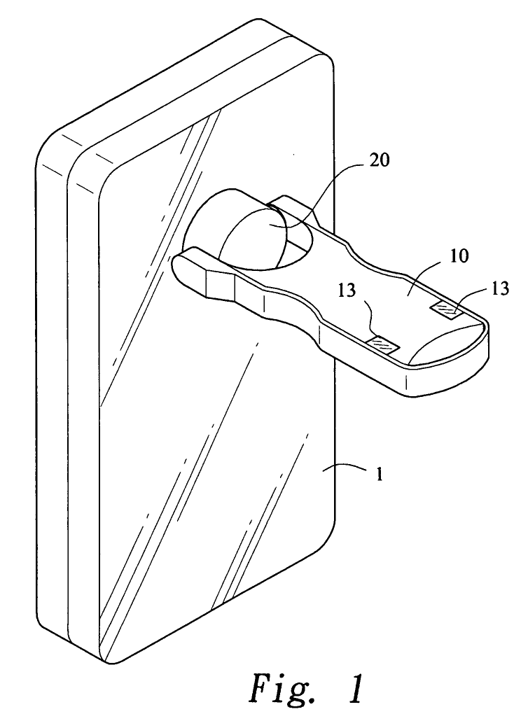

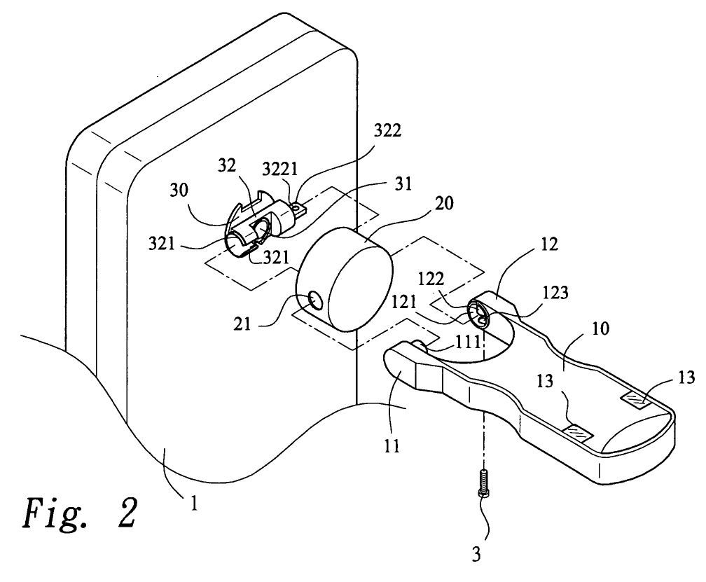

FIG. 1 shows a perspective view of the GPS device with a rotational antenna apparatus according to the present invention and FIG. 2 is an exploded view of the rotational antenna apparatus for the GPS device. The GPS device of the present invention comprises a receiving antenna 10, which can be of elongated bar shape, elongated panel shape, panel shape, circular panel shape or irregular shape. The receiving antenna 10 comprises a satellite receiving module and is connected to the GPS device 1 through a signal transmission line 2. The receiving antenna 10 comprises a pair of coupling legs 11 and 12 on one end thereof.

The coupling leg 11 comprises a hollow cylindrical post 111 for receiving the signal transmission line 2. The coupling leg 12 comprises an axial hole 121 with a threaded post 122. The threaded post 122 comprises a threaded hole 123 corresponding the coupling leg 12.

A coupling shaft 20 is of circular cap shape and comprises a pair of coupling holes 21 corresponding to the coupling legs 11 and 12. A rotational stage 30 is fixed to the casing of the GPS device and comprises a pivotal hole 31 through the casing of the GPS device 1. The rotational stage 30 comprises a rotational tenon 32 and a polygon nut 33 is used to lock the rotational tenon 32 to the pivotal hole 31.

The rotational tenon 32 comprises two annulus clips 321 on one side thereof and a pin 322 on another side thereof. The pin 322 comprises a thread hole 3221 thereon. The hollow cylindrical post 111 of the coupling leg 11 can be inserted into one coupling hole 21 of the coupling shaft 20 and between the two annulus clips 321.

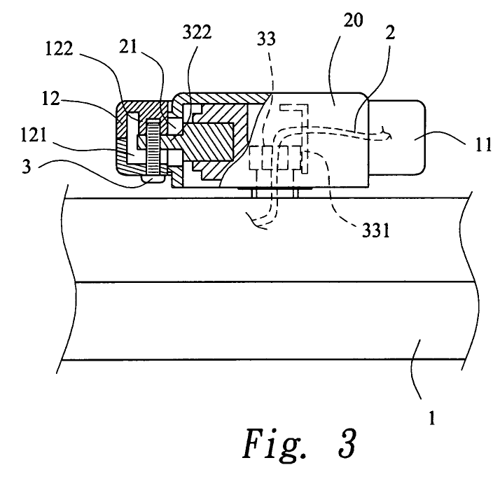

FIG. 3 shows a partial sectional view of the rotational structure of the present invention. The pin 322 of the rotational tenon 32 can also be inserted into another coupling hole of the coupling shaft 20 and then inserted into the axial hole 121 of the coupling leg 12. A screw 3 is engaged to the thread hole of the pin 322 after passing the threaded hole 123.

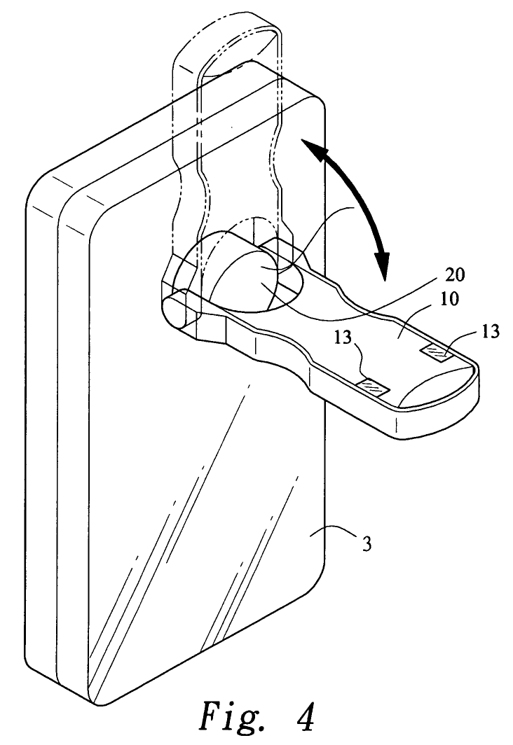

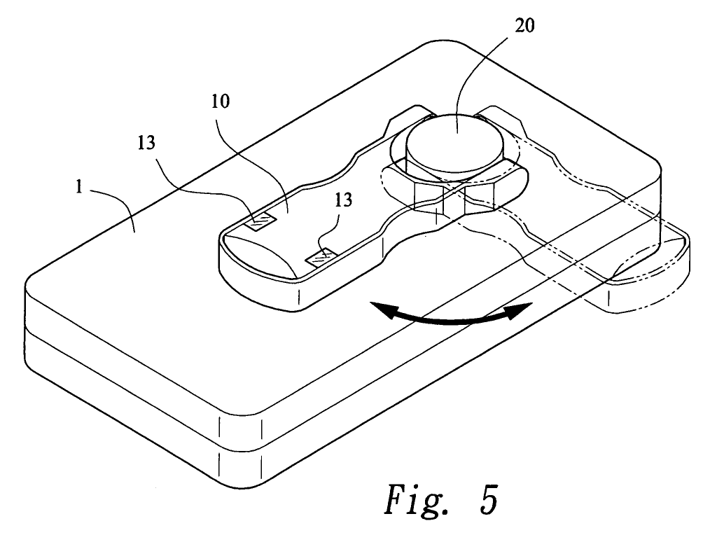

As shown in FIG. 4, after above-mentioned assembling, the receiving antenna 10 can have 180 degree rotation with the coupling hole 21 as a pivot. As shown in FIG. 5, the receiving antenna 10 can have 360 degree rotation with the pivotal hole 31 as a pivot.

With reference again to FIGS. 2 and 3, the signal transmission line 2 is connected to a satellite receiving module (not shown) and passes the hollow cylindrical post 111 of the coupling leg. The signal transmission line 2 also passes the coupling hole 21 of the coupling shaft 20.

The tenon 32 of the rotational stage 30 and the pivotal hole 31 is pivotally connected through a polygon nut 33. A clamping spring 331 is fixed to inner wall of the coupling shaft 20 on one end thereof. Another end of the clamping spring 331 is a free end and close to outer edge of the polygon nut 33. When the receiving antenna 10 is rotated, a clamping stair is formed by the clamping spring 331 and the outer edge of the polygon nut 33.

The receiving antenna 10 according to the present invention is preferably comprises a plurality of indicating lamps 13 to show the navigation direction according to a GPS software. The indicating lamps 13 preferably include a left-turn indicating lamp and a right-turn indicating lamp, which can be controlled by GPS software in the GPS device 1. The signal transmission line 2 is electrically connected to the indicating lamps 13 to inform user with left turn and right turn for next intersection. Therefore user needs not to keep paying attention on the monitor of GPS device 1. The indicating lamps 13 can be flashed with different frequencies to represent the distance to the intersection. The indicating lamps 13 can be preferably arranged on the GPS device 1.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A rotational antenna apparatus for GPS device, comprising:
a receiving antenna comprising a satellite receiving module and a pair of coupling legs on one end thereof;
a coupling shaft being of circular cap shape and comprising a pair of coupling holes on circumference thereof and corresponding to the coupling legs such that the receiving antenna can be pivotally connected to the coupling shaft and the receiving antenna has 180 degree rotation with the coupling hole as a pivot;
a rotational stage fixed to a casing of the GPS device and comprising a pivotal hole through the casing, a tenon pivotally connected to the pivotal hole, wherein the coupling hole is pivotally connected to the coupling leg of the receiving antenna and the receiving antenna has 360 degree rotation with the pivotal hole as a pivot.

2. The rotational antenna apparatus for GPS device as in claim 1 wherein the receiving antenna can be of elongated bar shape, elongated panel shape, panel shape, circular panel shape or irregular shape.

3. The rotational antenna apparatus for GPS device as in claim 1, further comprising a signal transmission line electrically connected to the satellite receiving module and passing the coupling hole by the coupling leg, the signal transmission line further passing the pivotal hole for connecting into the casing of the GPS device.

4. The rotational antenna apparatus for GPS device as in claim 1, wherein one coupling leg comprises a hollow cylindrical post and another coupling comprises an axial hole with a threaded post, the tenon comprises two annulus clips on one side thereof and a pin on another side thereof, the pin comprising a threaded hole and the hollow cylindrical post passing into one coupling hole and inserted between the annulus clips, the pin inserted into another coupling hole and inserted into the axial hole, a screw being inserted into the threaded hole of the pin and locked to the threaded post, whereby the receiving antenna can be movably and pivotally arranged.

5. The rotational antenna apparatus for GPS device as in claim 1, wherein the tenon is rotatably arranged in the pivotal hole and locked by a polygon nut, the tenon comprises a spring clamp with one end arranged on inner wall of the coupling shaft and another end being a free end and near outer edge of the polygon nut, when the receiving antenna is rotated, the spring clamp and the outer edge of the polygon nut forms a clamping stair.

6. The rotational antenna apparatus for GPS device as in claim 1, further comprising a plurality of indicating lamps embedded on the receiving antenna and used to indicate navigation direction of the GPS device.

7. The rotational antenna apparatus for GPS device as in claim 6, wherein the indicating lamps are controlled by GPS software in the GPS device and the signal transmission line is connected to the indicating lamps.

8. The rotational antenna apparatus for GPS device as in claim 6, wherein the indicating lamps comprise a left-turn indicating lamp and a right-turn indicating lamp.

9. The rotational antenna apparatus for GPS device as in claim 6, wherein the indicating lamps can be arranged on the GPS device.
